(19) United States
(12) Patent Application Publication
(10) Pub. No.: US 2012/0091968 A1
(43) Pub. Date: Apr. 19, 2012

(54) METHOD AND APPARATUS FOR TRACKING MAXIMUM POWER POINT

(75) Inventors: Sewan HEO, Daejeon (KR); Yil Suk Yang, Daejeon (KR); Jongdae Kim, Daejeon (KR)

(73) Assignee: ELECTRONICS AND TELECOMMUNICATIONS RESEARCH INSTITUTE, Daejeon (KR)

(21) Appl. No.: 13/186,896

(22) Filed: Jul. 20, 2011

(30) Foreign Application Priority Data
Oct. 18, 2010 (KR) 10-2010-0101515

(51) Int. Cl. H02J 7/00

(52) U.S. Cl. 320/138

(57) ABSTRACT

Disclosed are a method and an apparatus for tracking a maximum power point. An apparatus for tracking a maximum power point according to an exemplary embodiment of the present disclosure includes: a system controller monitoring a plurality of energy sources for each predetermined period and selecting an energy source having a maximum power among the plurality of energy sources; and a maximum power tracking unit limiting an output voltage of the selected energy source to a reference voltage determined by an open circuit voltage of the selected energy source to track the maximum power point from the selected energy source and store the power of the selected energy source in a battery.

### CROSS-REFERENCE TO RELATED APPLICATIONS

This application is based on and claims priority from Korean Patent Application No. 10-2010-0101515, filed on Oct. 18, 2010, with the Korean Intellectual Property Office, the disclosure of which is incorporated herein in its entirety by reference.

### TECHNICAL FIELD

The present disclosure relates to a method and an apparatus for tracking a maximum power point, and more particularly, to a method and an apparatus for tracking a maximum power point capable of tracking a maximum power point by monitoring an energy source for each period while reflecting characteristics of energy sources that changes according to the environments and time, while selecting one generating the maximum power among a plurality of energy sources and tracking the maximum power point from the selected energy source.

### BACKGROUND

Various types of new renewable energy sources have currently been in the limelight as alternative energy sources. Representative renewable energy sources include a photovoltaic power generation, an hydroelectric power generation, and a wind power generation. Most of the new renewable energy sources require large-scale facilities. In addition, there are energy sources generating a small amount of energy requiring small-scale facilities such as a piezoelectric device that generates energy by vibrations or pressure, and a thermoelectric device that generates energy using a temperature difference, and so on.

Meanwhile, the characteristics of the new renewable energy sources are changed depend on the environments and time. For example, for a solar cell, a power generation amount varies according to the amount of sunshine and the light intensity. For the piezoelectric element, the power generation amount varies according to the size of vibrations, and for the thermoelectric element, the power generation amount varies according to the temperature difference. For the energy sources that changes the power generation amount according to the environment and time, it is important to track the energy with a maximum efficiency through a separate control in the course of an energy tracking process.

In connection with this, there are various types of technologies that track the maximum power point in the related art. As a representative method, the characteristics of energy sources are investigated in advance according to various environments. The method then checks current environment, and tracks a maximum power point based on the previously determined information, thereby forming a condition that can track the maximum power point. As another method, there is a method for obtaining a maximum power point by calculating power generated in real time and changing conditions in a direction where the generated power is increased. The former case has a disadvantage in that it needs to determine all the characteristics of energy sources according to various environments, and the latter case has a disadvantage in that the state of the energy sources needs to be monitored and the conditions need to be changed continuously.

There is a problem in that the methods in the related arts need to know all the conditions and calculate power by continuously changing the conditions. Therefore, the former case is hard to be applied to various energy sources and the latter case consumes a large amount of power due to the continuous monitoring.

### SUMMARY

The present disclosure has been made in an effort to solve the problem described above and to provide a method and an apparatus for tracking a maximum power point capable of being applied to a plurality of energy sources without previously determining characteristics of energy sources according to various conditions, and greatly reducing power consumption while performing a continuous monitoring operation through a periodic operation.

An exemplary embodiment of the present disclosure provides an apparatus for tracking a maximum power point, including: a system controller to monitor a plurality of energy sources for each predetermined period, and to select an energy source having a maximum power among the plurality of energy sources; and a maximum power tracking unit to limit the output voltage of the selected energy source to a reference voltage determined by an open circuit voltage of the selected energy source in order to track the maximum power point from the selected energy source, and store the power of the selected energy source in a battery.

Another exemplary embodiment of the present disclosure provides a method for tracking a maximum power point, including: confirming the charging state of a battery; selecting an energy source having a maximum power among a plurality of energy sources when the charging state of the battery is in an insufficient state; tracking the maximum power point from the selected energy source by limiting an output voltage of the selected energy source to a reference voltage determined by an open circuit voltage of the selected energy source; and storing the power of the selected energy source in the battery.

According to the exemplary embodiments of the present disclosure as described above, the method and the apparatus for tracking the maximum power point can track the maximum power point by monitoring the plurality of energy sources for each predetermined period and selecting the energy source having the maximum power among the plurality of energy sources. As a result, the method and the apparatus may be applied to the plurality of energy sources without previously determining the characteristics of the energy sources according to various conditions, and can track the maximum power point from the plurality of energy sources through the periodic operation.

Further, the method and apparatus for tracking a maximum power point can monitor the charging amount of the battery and control the energy consumption of each component in the apparatus to prevent the battery from overcharging and over-discharging, such that a semi-permanently operating apparatus can be provided.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram showing the configuration of an apparatus for tracking a maximum power point, according to an exemplary embodiment of the present disclosure.

FIG. 2 is a graph showing the relationship between an open circuit voltage and a maximum power voltage.

FIG. 3 is a diagram showing the operation mode of each unit in the apparatus for tracking a maximum power point according to an operational period.

FIG. 4 is a graph showing the consumed power and battery accumulation energy according to energy charging and discharging of the apparatus for tracking a maximum power point, according to an exemplary embodiment of the present disclosure.

FIG. 5 is a flow chart showing a method for tracking a maximum power point, according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

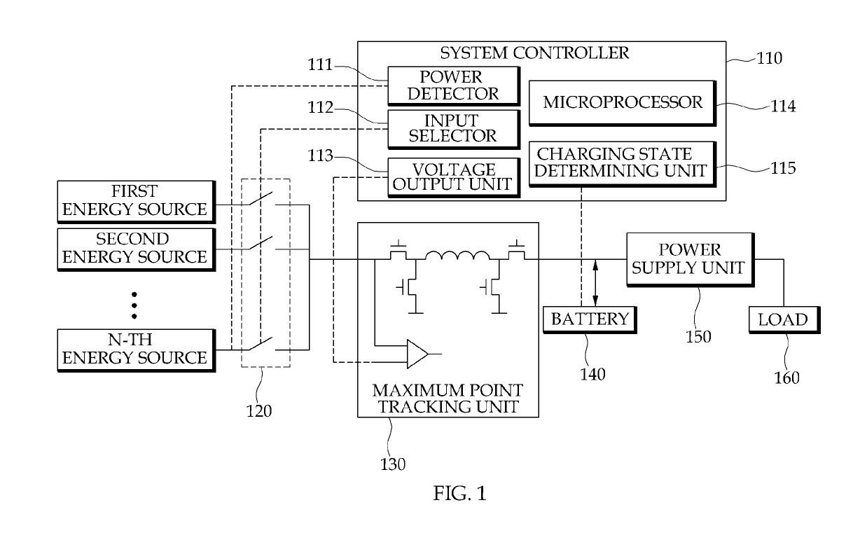

FIG. 1 is a block diagram showing the configuration of an apparatus for tracking the maximum power point, according to an exemplary embodiment of the present disclosure.

Referring to FIG. 1, an apparatus for tracking a maximum power point according to the exemplary embodiment of the present disclosure includes a system controller 110, a switch unit 120, a maximum power tracking unit 130, a battery 140, a power supplier 150, and a load 160. In this configuration, system controller 110 includes a power detector 111, an input selector 112, a voltage output unit 113, a microprocessor 114, and a charging state determining unit 115.

System controller 110 monitors a plurality of energy sources for each predetermined period and selects an energy source having a maximum power among the plurality of energy sources. In this configuration, the predetermined period may be determined as a time when the energy amount of the energy source is constant due to the small change in environment.

Hereinafter, a detailed operation of each unit configuring system controller 110 will be described.

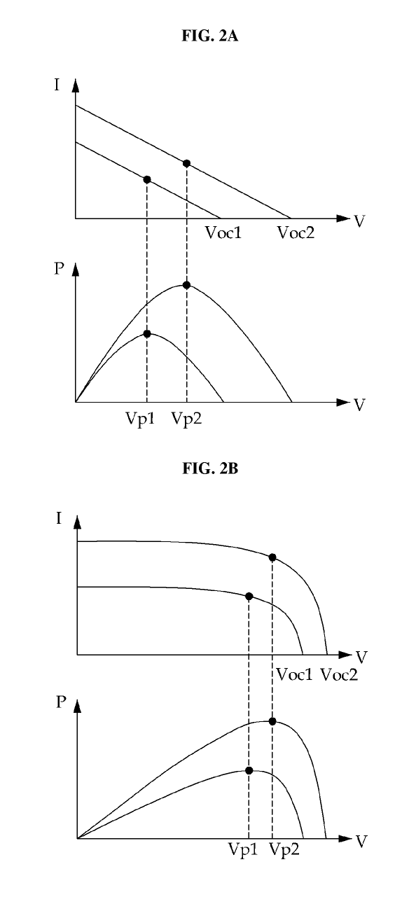

Power detector 111 measures an open circuit voltage of each energy source and detects power of each energy source. In detail, power detector 111 detects power of each energy source by measuring an open circuit voltage that is a voltage generated when an output voltage from each energy source rises to a threshold in the state where switch unit 120 is switched-off, and measuring voltage and current generated from maximum power tracking unit 130 according to a reference voltage in the state where switch unit 120 is switched-on. In this case, the reference voltage may be determined by using the open circuit voltage and the detailed contents thereof will be described in detail with reference to FIG. 2.

Input selector 112 controls switch unit 120 according to the instructions of microprocessor 114. That is, input selector 112 serves to turn-on/off each switch connecting each energy source to maximum power tracking unit 130. Input selector 112 selects an energy source by turning-on at least one of a plurality of switches configuring switch unit 120 by the instructions of microprocessor 114.

Voltage output unit 113 outputs the reference voltage of the energy source to maximum power tracking unit 130. Voltage output unit 113 outputs the reference voltage of each energy source to maximum power tracking unit 130 when selecting the energy source having the maximum power and then, outputs the reference voltage of the selected energy source to maximum power tracking unit 130 when the energy source having the maximum power is selected. The reference voltage is used to limit the output voltage of the selected energy source by the maximum power tracking unit 130.

Microprocessor 114 serves to control power detector 111, input selector 112, voltage output unit 113, and charging state determining unit 115 that configure system controller 110. Microprocessor 114 sets the reference voltage having the maximum power for each energy source by using the open circuit voltage of each energy source measured by power detector 111. Microprocessor 114 confirms an energy source having the maximum power among the plurality of energy sources, based on the power of each energy source detected by power detector 111.

In addition, microprocessor 114 divides the operation period of the apparatus for tracking a maximum power point into three periods including a system operation period, a load operation period, and a low power charging period. Microprocessor 114 sets the operations of microprocessor 114, power detector 111, input selector 112, charging state determining unit 115, power supplier 150, and load 160 as an operation mode, a low power operation mode, and a non-operation mode according to each period.

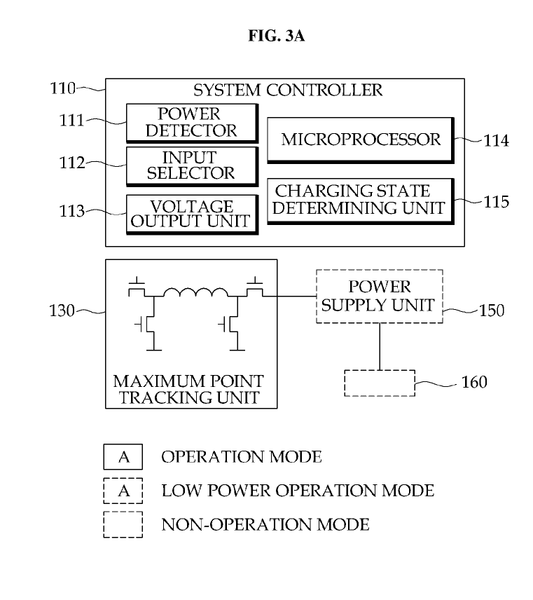

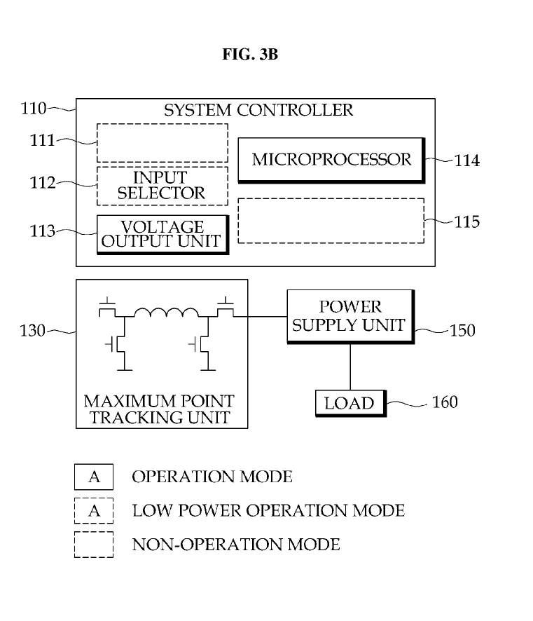

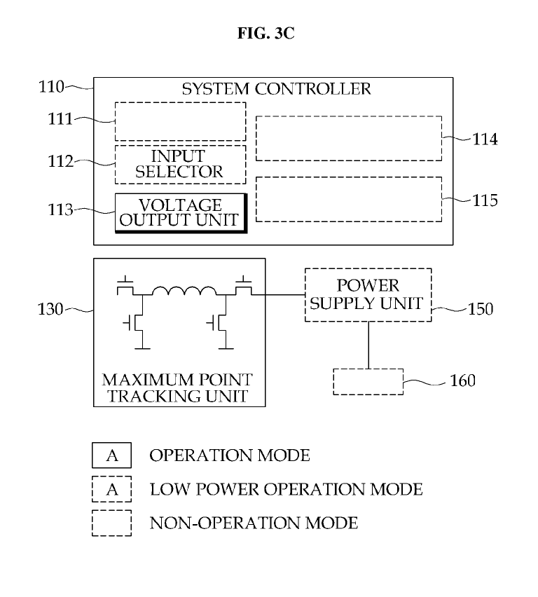

The detailed method of allowing microprocessor 114 to set the operation modes of each unit in the apparatus for tracking a maximum power point according to the operation periods of the tracking apparatus will be described in detail with reference to FIG. 3.

In addition, microprocessor 114 checks the charging state of battery 140 confirmed by charging state determining unit 115 to reduce the operation of load 160 when the charging state of battery 140 is in an insufficient state and to disconnect the selected energy sources when the charging state of battery 140 is in an excessive state. In addition, microprocessor 114 may determine whether load 160 is operated, the operation contents, the operation timing, and the operation time of the load according to the charging state of battery 140.

Charging state determining unit 115 measures the voltage or confirms the charging state of battery 140 through the communication with battery 140. In detail, charging state determining unit 115 may simply measure the voltage of battery 140 to confirm the charging state of battery 140. Alternatively, charging state determining unit 115 may incorporate a communication module communicating with a communication module embedded in battery 140 to receive information indicating the charging state from battery 140, such that the charging state of battery 140 can be confirmed.

Maximum power tracking unit 130 stores the power supplied from the energy source selected by system controller 110 in battery 140. In this case, maximum power tracking unit 130 limits the output voltage of the selected energy source by using the reference voltage output from voltage output unit 113 of system controller 110, such that the maximum power can be obtained from the selected energy source. To this end, maximum power tracking unit 130 may function as a DC-DC converter.

Battery 140 stores power supplied through maximum power tracking unit 130 from the selected energy source and supplies the stored power to each component constituting load 160 and system controller 110.

In addition, battery 140 may inform its own charging state to charging state determining unit 115 of system controller 110. In detail, battery 140 simply supplies output voltage to charging state determining unit 115 or incorporates the communication module communicating with the communication module embedded in charging state determining unit 115 to transmit information indicating its own charging state to charging state determining unit 115, such that the charging state of battery can be informed.

Power supplier 150 supplies the power of battery 140 to load 160, according to the voltage of load 160, when the voltage of battery 140 is different from the voltage of load 160. To this end, power supplier 150 may be implemented as a DC-DC converter similarly to maximum power tracking unit 130.

Load 160 uses power stored in battery 140. Load 160 may include a transmitter and a receiver that transmits desired information to the outside by system controller 110 or external information to system controller 110. In addition, load 160, which includes a temperature sensor, and a heat sensor, may transmit sensed information to the outside through the transmitter.

FIG. 2 is a graph showing the relationship between the open circuit voltage and the maximum power voltage. FIG. 2A is a graph showing the relationship between the open circuit voltage and the maximum power voltage in the thermoelectric device, and FIG. 2B is a graph showing the relationship between the open circuit voltage and the maximum power voltage in the solar cell.

As shown in FIG. 2, when an open circuit voltage Voc is increased, the voltage corresponding to the maximum power, that is maximum power voltage Vp, is increased accordingly.

Referring to FIG. 2A, for the thermoelectric element, a ½ value of open circuit voltages Voc1 and Voc2 approximates to maximum power voltages Vp1 and Vp2. Therefore, when the reference voltage is set to be ½ of the open circuit voltage, it is possible to track the maximum power point.

Referring to FIG. 2B, in the case of the solar cell, a ¾ value of open circuit voltages Voc1 and Voc2 approximates to maximum power voltages Vp1 and Vp2. Therefore, when the reference voltage is set to be ¾ of the open circuit voltage, it is possible to track the maximum power point.

FIG. 3 is a diagram showing the operation mode of each unit in an apparatus for tracking a maximum power point according to the operational period of the tracking apparatus.

System controller 110 plays a role in controlling the operation of tracking the maximum power point from the energy source. However, system controller 110 has a problem of consuming a large amount of power for the control operation.

In order to solve the problems as described above, the exemplary embodiment of the present disclosure does not affect the charging operation of the battery by tracking the maximum power point while reducing the unnecessary power consumption through minimizing the operation period of system controller 110.

To this end, as shown in FIG. 3, the exemplary embodiment of the present disclosure divides the operation period of the apparatus for tracking a maximum power point into three types of periods. In each period, system controller 110, maximum power tracking unit 130, power supplier 150, and load 160 are selected to operate as one of the operation mode, the low power operation mode, and the non-operation mode, such that the power consumption can be reduced.

FIG. 3A is a diagram showing the operation mode of each unit in the system operation period, FIG. 3B is a diagram showing the operation mode of each unit in the load operation period, and FIG. 3C is a diagram showing the operation mode of each unit in the low power charging period. In this case, the system operation period is a period for selecting the energy source having the maximum power by measuring the power of the plurality of energy sources, the load operation period is a period in which load 160 is operated by the discharge of battery 140, and the low power charging period is a period in which battery 140 is charged.

Referring to FIG. 3A, in the system operation period, microprocessor 114 maintains system controller 110 and maximum power tracking unit 130 as the operation mode, power supplier 150 as the low power operation mode, and load 160 as the non-operation mode.

Referring to FIG. 3B, in the load operation mode, microprocessor 114 maintains microprocessor 114, power supplier 150, and load 160 as the operation mode, input selector 112 as the low power operation mode, and power detector 111 and charging state determining unit 115 as the non-operation mode.

Referring to FIG. 3C, in the low power charging mode, microprocessor 114 maintains input selector 112 and power supplier 150 as the low power operation mode, and power detector 111, microprocessor 114, charging state determining unit 115, and load 160 as the non-operation mode.

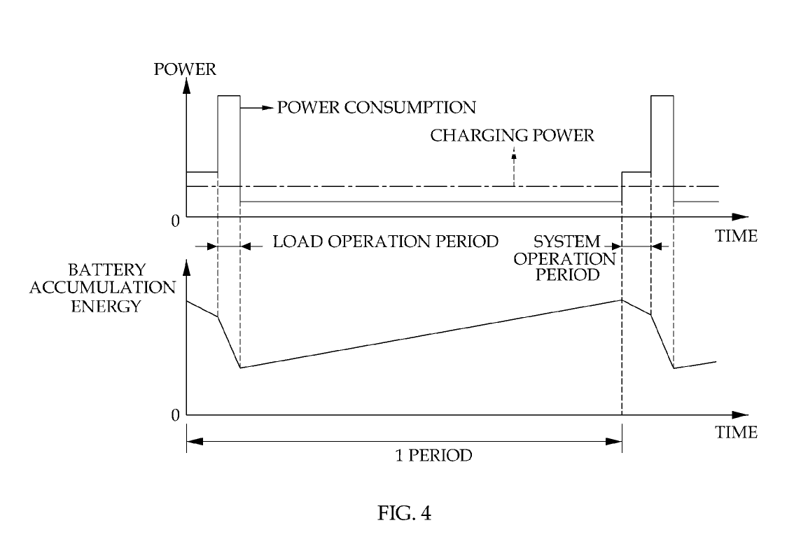

FIG. 4 is a graph showing power and battery accumulation energy consumed according to the energy charging and discharging of the tracking apparatus, according to an exemplary embodiment of the present disclosure.

Referring to FIG. 4, it can be appreciated that a considerable amount of power is consumed in the load operation period and the system operation period.

Therefore, the exemplary embodiment of the present disclosure not only tracks the maximum power point from the plurality of energy sources but also controls the time and frequency of the system operation period and the load operation period in which energy is consumed, thereby preventing the energy accumulated in the battery from overcharging or overdischarging, even though the charging energy is large or small. In addition, the exemplary embodiment of the present disclosure increases or reduces a time of 1 period, thereby preventing the overcharging and overdischarging.

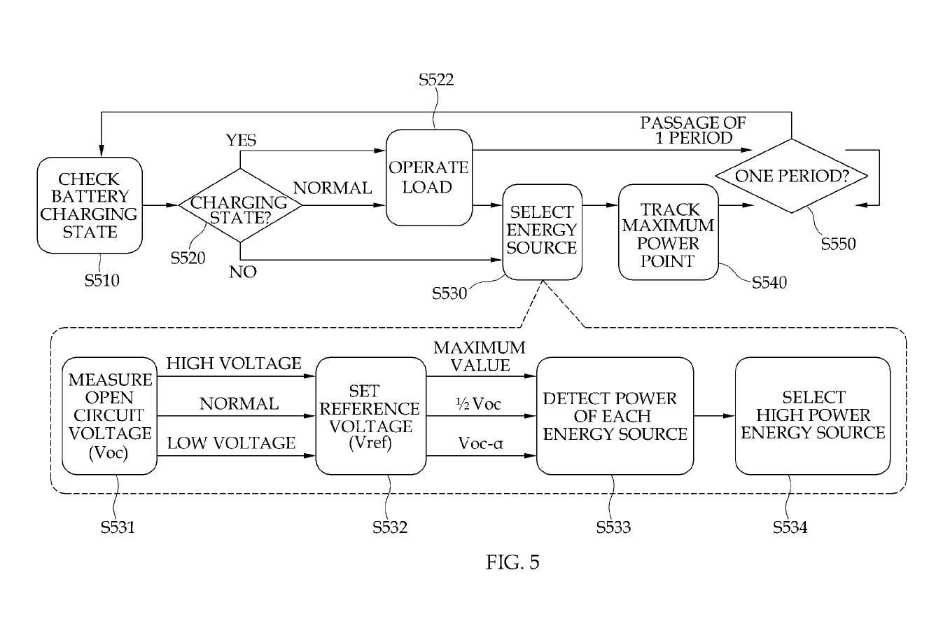

FIG. 5 is a flow chart showing a method for tracking a maximum power point according to an exemplary embodiment of the present disclosure.

Referring to FIG. 5, microprocessor 114 checks the charging state of battery 140 using charging state determining unit 115 (S510) to determine whether the charging state of battery 140 is in an excessive state, a normal state, or an insufficient state (S520).

When the charging state of battery (140) is insufficient, microprocessor 114 selects the energy source having the maximum power among the plurality of energy sources using input selector 112 (S530). In this case, a method for allowing microprocessor 114 to select the energy source having the maximum power among the plurality of energy sources is as follows.

Microprocessor 114 measures the open circuit voltage of each energy source using power detector 111 (S531). At this time, microprocessor 114 opens all the switches of switch unit 120 to measure the open circuit voltage of each energy source.

Microprocessor 114 uses the measured open circuit voltage to set the reference voltage having the maximum power for each energy source (S532).

Microprocessor 114 outputs the set reference voltage to maximum power tracking unit 130 through voltage output unit 113, and detects power of each energy source from the voltage and current generated from maximum power tracking unit 130 using power detector 111 (S533).

Microprocessor 114 confirms the power of each energy source detected through power detector 111 and selects the energy source having the maximum power among the plurality of energy sources through input selector 112 (S534). In this case, microprocessor 114 may select at least two energy sources having the maximum power among the plurality of energy sources when the same type of energy sources are present among the plurality of energy sources.

Next, when the reference voltage of the selected energy source by microprocessor 114 is output to maximum power tracking unit 130 through voltage output unit 113, maximum power tracking unit 130 stores maximum power in battery 140 while tracking the maximum power point using the reference voltage (S540). In this case, maximum power tracking unit 130 limits the output voltage of the selected energy source to the reference voltage determined by the open circuit voltage of the selected energy source in order to track the maximum power point from the selected energy source.

System controller 110 determines whether one (1) period ends (S550). If it is determined that the one (1) period ends, system controller 110 returns to the process of confirming the charging state of battery 140 to repeatedly perform the process.

Hereinafter, the process for tracking a maximum power point will be described with reference to the case where the energy source is a solar cell and a thermoelectric device, by way of example.

First, the open circuit voltage is measured by opening two energy sources, and determines the reference voltage of each energy source.

Next, the reference voltage for the solar cell is output through voltage output unit 113 by connecting the solar cell to operate maximum power tracking unit 130, and measures the power of the solar cell from the voltage/current generated from maximum power tracking unit 130.

Next, the reference voltage for the thermoelectric device is output through voltage output unit 113 by connecting the thermoelectric device instead of the solar cell to operate maximum power tracking unit 130, and measures the power of the thermoelectric device from the voltage/current generated from maximum power tracking unit 130.

Thereafter, the powers between the solar cell and the thermoelectric device are compared, and an energy source having a larger power is selected. A maximum power point is then tracked from the selected energy source and stored in battery 140.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An apparatus for tracking a maximum power point, comprising:
a system controller configured to monitor a plurality of energy sources for each predetermined period, and select an energy source having a maximum power among the plurality of energy sources; and
a maximum power tracking unit configured to limit an output voltage of the selected energy source to a reference voltage determined by an open circuit voltage of the selected energy source, in order to track the maximum power point from the selected energy source and store the power of the selected energy source in a battery.

2. The apparatus of claim 1, wherein the system controller includes:
a power detector configured to measure the open circuit voltage of each energy source and detect the power of each energy source;
a microprocessor configured to set a reference voltage having a maximum power for each energy source using the open circuit voltage of each energy source measured by the power detector, and to confirm an energy source having the maximum power among the plurality of energy sources based on the power of each energy source detected by the power detector;
an input selector configured to select the energy source by controlling a switch unit including a plurality of switches corresponding to the plurality of energy sources by instructions from the microprocessor;
a voltage output unit outputting the reference voltage of the selected energy source to the maximum power tracking unit; and
a charging state determining unit confirming the charging state of the battery.

3. The apparatus of claim 2, wherein the power detector detects power of each energy source by measuring the open circuit voltage that is a voltage generated when an output voltage of each energy source rises to a threshold in a state where the switch unit is switched-off, and measuring voltage and current generated from the maximum power tracking unit according to the reference voltage in a state where the switch unit is switched-on.

4. The apparatus of claim 2, further comprising a power supplier configured to supply the power stored in the battery to the load according to the voltage of the load when the voltage of the battery is different from the voltage of the load.

5. The apparatus of claim 4, wherein the microprocessor divides the operation period of the apparatus for tracking a maximum power point into three types of periods including a system operation period, a load operation period, and a low power charging period,
the microprocessor maintains the system controller and the maximum power tracking unit as an operation mode, the power supplier as the low power operation mode, and the load as the non-operation mode, in the system operation period,
the microprocessor keeps the microprocessor, the power supplier, and the load as the operation mode, the input selector as the low power operation mode, and the power detector and the charging state determining unit as the non-operation mode, in the load operation period, and
the microprocessor keeps the input selector and the power supplier as the low power operation mode, and the power detector, the microprocessor, the charging state determining unit, and the load as the non-operation mode, in the lower power charging period.

6. The apparatus of claim 5, wherein the microprocessor controls the time and frequency of the system operation period and the load operation period, according to the charging state of the battery.

7. The apparatus of claim 2, wherein the microprocessor changes the predetermined period, according to the charging state of the battery.

8. The apparatus of claim 2, wherein the microprocessor determines whether or not the load is operated, operation contents, an operation timing, and an operation time of the load, according to the charging state of the battery.

9. The apparatus of claim 2, wherein the microprocessor disconnects the selected energy source, according to the charging state of the battery.

10. The apparatus of claim 2, wherein the charging state determining unit incorporates a communication module communicating with a communication module embedded in the battery to receive information indicating the charging state from the battery, and confirm the charging state of the battery.

11. The apparatus of claim 2, wherein the charging state determining unit measures the voltage of the battery to confirm the charging state of the battery.

12. A method for tracking a maximum power point, comprising:
confirming a charging state of a battery;
selecting an energy source having a maximum power among a plurality of energy sources when the charging state of the battery remains in an insufficient state of charge;
tracking a maximum power point from the selected energy source by limiting an output voltage of the selected energy source to a reference voltage determined by an open circuit voltage of the selected energy source; and
storing the power of the selected energy source in the battery.

13. The method of claim 12, wherein the selecting of the energy source includes:
detecting the open circuit voltage of each energy source;
setting a reference voltage having the maximum power for each energy source using the detected open circuit voltage;
measuring the power of each energy source in the set reference voltage; and
selecting an energy source having the maximum power among the plurality of energy sources according the measured results.

14. The method of claim 12, further comprising operating the load when the charging state of the battery remains in an excessive state or a normal state, after the confirming of the charging state.

15. The method of claim 12, further comprising:
determining whether or not one (1) period ends,
wherein if it is determined that the one (1) period ends, the method returns to the confirming of the charging state.
